(19) United States
(12) Patent Application Publication
(10) Pub. No.: US 2025/0023760 A1
(43) Pub. Date: Jan. 16, 2025

(54) NETWORK NODE AND USER EQUIPMENT FOR ESTIMATION OF A RADIO PROPAGATION CHANNEL

(71) Applicant: Telefonaktiebolaget LM Ericsson (publ), Stockholm (SE)

(72) Inventors: Milad FOZOONI, Göteborg (SE); Sairamesh NAMMI, Austin, TX (US)

(73) Assignee: Telefonaktiebolaget LM Ericsson (publ), Stockholm (SE)

(21) Appl. No.: 18/711,445

(22) PCT Filed: Nov. 23, 2021
(86) PCT No.: PCT/EP2021/082637

§ 371 Date: May 17, 2024

(51) Int. Cl. H04L 25/02; H04B 7/0413; H04L 27/26

(52) U.S. Cl. CPC H04L 25/0224; H04B 7/0413; H04L 27/2623

(57) ABSTRACT

There is provided mechanisms for estimating a radio propagation channel. A method is performed by a network node. The network node serving a user equipment over the radio propagation channel. The method comprises configuring (S104) the user equipment to use single port transmission for transmitting on an uplink data channel to the network node. The method comprises transmitting (S106) downlink control information towards the user equipment. The downlink control information indicates which port the user equipment is to use for transmission of DMRS on the uplink data channel. The method comprises receiving (S108) uplink reference signals from the user equipment and uplink data and the DMRS on the uplink data channel from the user equipment. The method comprises determining (Slid) a channel estimate of the radio propagation channel, and a null space estimate of the radio propagation channel, from the received uplink reference signals and the received DMRS.

### TECHNICAL FIELD

Embodiments presented herein relate to a method, a network node, a computer program, and a computer program product for estimating a radio propagation channel. Embodiments presented herein further relate to a method, a user equipment, a computer program, and a computer program product for assisting the network node in estimating the radio propagation channel.

### BACKGROUND

Multiple-input multiple-output (MIMO) techniques is one way to significantly increase the throughput of wireless communication systems. Therefore, MIMO techniques are an integral part of the third generation (3G) and fourth generation (4G) telecommunication standards. In fifth generation (5G) systems telecommunication standards MIMO techniques with a large number of antennas, called massive MIMO, is used. Typically, with a setup of (Nₜ, Nᵣ) antennas, where Nₜ denotes the number of transmit antennas and Nᵣ the number of receive antennas, the peak data rate scales up with a factor of Nₜ over single antenna systems in a rich scattering environment.

FIG. 1 shows a sequence diagram for a reciprocity-based communication system where MIMO techniques are used. Before the actual data transmission, the network, as represented by a network node, configures the user, as represented by a user equipment, with uplink reference signal (such as sounding reference signal; SRS) periodicity, resource configuration, downlink reference signal (such as channel state information reference signal; CSI-RS) periodicity, downlink reference signal resource configuration, channel state information (CSI) configuration, etc. using radio resource control (RRC) signalling (step 1). The user equipment transmits the uplink reference signal according to the configured periodicity and the resource configuration (step 2). The network node computes precoding weights based on the received uplink reference signal (step 3). The network node periodically transmits the downlink reference signal (step 4). The user equipment computes (step 5) the CSI, for example comprising rank indicator (RI), channel quality indicator (CQI), precoding matrix index (PMI) and layer indicator (LI) and feeds (step 6) the CSI back to the network node over an uplink control, or shared, channel. Once the network node receives the CSI, the network node uses the RI and the CQI received from the user equipment, and a PMI computed at the network node based on the received uplink reference signal to schedule the user equipment and to perform the actual data transmission (step 7).

Further, in addition to uplink and downlink reference signals, also demodulation reference signal (DMRS) can be transmitted by the network node and the user equipment. In general terms, DMRS is used to estimate the radio channel for demodulation. DMRS as transmitted from the network node is device-specific, can be beamformed, confined in a scheduled resource, and transmitted only when necessary. To support multiple-layer MIMO transmission, multiple orthogonal DMRS ports can be scheduled, one for each layer. FIG. 2 shows a resource block of an Orthogonal frequency-division multiplexing (OFDM) symbol in time/frequency grid. The OFDM resource block is composed of resource elements (REs) spread over 12 subcarriers. In the examples of FIG. 2, a DMRS is, on a single port, transmitted on six resource elements within the OFDM symbol.

As indicated by the OFDM symbol in FIG. 2, OFDM transmission can be used for both downlink (DL; from the network to the user) and uplink (UL; from the user to the network) transmissions. The transmit signals when using OFDM transmissions can have high peak amplitude values in the time domain since many subcarrier components are added via an Inverse fast Fourier transform (IFFT) operation. Therefore, OFDM symbols are known to have a high peak to average power ratio (PAPR) compared with single-carrier systems. The high PAPR push the transmit signal to the nonlinear region of high-power amplifiers (HPA) and imposes in-band and out-of-band distortion. This in-band and out-of-band distortion can respectively deteriorate the system performance in terms of error vector magnitude (EVM) and adjacent channel power ratio (ACPR) in the same cell as well as in neighboring cells. In fact, high PAPR is one of the most detrimental aspects of the OFDM transmission, as it decreases the signal-to-quantization noise ratio (SQNR) of analog-to-digital converters (ADC) and digital-to-analog converters (DAC) as a consequence of low efficiency of the HPAs in the transmitter.

One technique to avoid the large peak amplitude values is to use a large power back off. However, it is inefficient to run the HPAs with a large power back off and still maintain the same cell coverage. Hence, many crest factor reduction (CFR) techniques have been proposed in the literature. Clipping and filtering (CF) is a well-known conventional technique where the peaks of the time-domain signal are clipped the out-of-band emissions are filtered several times, before the transmit signal is sent through the HPAs. However, this technique still suffers from in-band emission which results in a high EVM. Thus, CF might not meet stringent EVM requirements, in particular for high modulation schemes, with a heavy clipping. FIG. 3 shows the PAPR in dB versus receiver EVM in percent (%) with the CP technique, and Table 1 shows some exemplary EVM requirements for different types of modulation (where QPSK is short for quadrature phase shift keying and QAM is short for quadrature amplitude modulation).

TABLE 1
EVM requirements as a function of modulation

| Modulation | EVM Requirement (%) |
|---|---|
| QPSK | 17.5 |
| 16 QAM | 12.5 |
| 64 QAM | 8 |
| 256 QAM | 3.5 |
| 1024 QAM | 2.5 |

It can be observed that to meet the EVM requirements, it is not possible to clip beyond a certain limit. As a result, the PAPR cannot be reduced by more than 7 dB.

Hence, techniques are needed that can help to reduce the PAPR whilst at the same time maintain the EVM requirements.

### SUMMARY

A general object of embodiments disclosed herein is to address the above issues and provide techniques that enable the PAPR to be reduced whilst not impacting the EEVM requirements.

In some aspects, the object is met by using accurate estimates of the channel nulls, or null space, of the radio propagation channel.

A particular object of embodiments disclosed herein is therefore to provide techniques for accurate estimation of the null space of the radio propagation channel.

According to a first aspect there is presented a method for estimating a radio propagation channel. The method is performed by a network node. The network node serving a user equipment over the radio propagation channel. The method comprises configuring the user equipment to use single port transmission for transmitting on an uplink data channel to the network node. The method comprises transmitting downlink control information towards the user equipment. The downlink control information indicates which port the user equipment is to use for transmission of DMRS on the uplink data channel.

The method comprises receiving uplink reference signals from the user equipment and uplink data and the DMRS on the uplink data channel from the user equipment. The method comprises determining a channel estimate of the radio propagation channel, and a null space estimate of the radio propagation channel, from the received uplink reference signals and the received DMRS.

According to a second aspect there is presented a network node for estimating a radio propagation channel. The network node is configured to serve a user equipment over the radio propagation channel. The network node comprises processing circuitry. The processing circuitry is configured to cause the network node to configure the user equipment to use single port transmission for transmitting on an uplink data channel to the network node. The processing circuitry is configured to cause the network node to transmit downlink control information towards the user equipment. The downlink control information indicates which port the user equipment is to use for transmission of DMRS on the uplink data channel. The processing circuitry is configured to cause the network node to receive uplink reference signals from the user equipment and uplink data and the DMRS on the uplink data channel from the user equipment. The processing circuitry is configured to cause the network node to determine a channel estimate of the radio propagation channel, and a null space estimate of the radio propagation channel, from the received uplink reference signals and the received DMRS.

According to a third aspect there is presented a network node for estimating a radio propagation channel. The network node is configured to serve a user equipment over the radio propagation channel. The network node comprises a configure module configured to configure the user equipment to use single port transmission for transmitting on an uplink data channel to the network node. The network node comprises a transmit module configured to transmit downlink control information towards the user equipment. The downlink control information indicates which port the user equipment is to use for transmission of DMRS on the uplink data channel. The network node comprises a receive module configured to receive uplink reference signals from the user equipment and uplink data and the DMRS on the uplink data channel from the user equipment. The network node comprises a determine module configured to determine a channel estimate of the radio propagation channel, and a null space estimate of the radio propagation channel, from the received uplink reference signals and the received DMRS.

According to a fourth aspect there is presented a computer program for estimating a radio propagation channel, the computer program comprising computer program code which, when run on processing circuitry of a network node, causes the network node to perform a method according to the first aspect.

According to a fifth aspect there is presented a method for assisting a network node in estimating a radio propagation channel. The method is performed by a user equipment is served by the network node over the radio propagation channel. The method comprises receiving configuration from the network node for the user equipment to use single port transmission for transmitting on an uplink data channel to the network node. The method comprises receiving downlink control information from the network node. The downlink control information indicates which port the user equipment is to use for transmission of DMRS on the uplink data channel. The method comprises transmitting uplink reference signals towards the network node and uplink data and the DMRS on the uplink data channel, in accordance with the configuration, towards the network node, thereby assisting the network node in estimating the radio propagation channel.

According to a sixth aspect there is presented a user equipment for assisting a network node in estimating a radio propagation channel. The user equipment is configured to be served by the network node over the radio propagation channel. The user equipment comprises processing circuitry. The processing circuitry is configured to cause the user equipment to receive configuration from the network node for the user equipment to use single port transmission for transmitting on an uplink data channel to the network node. The processing circuitry is configured to cause the user equipment to receive downlink control information from the network node. The downlink control information indicates which port the user equipment is to use for transmission of DMRS on the uplink data channel. The processing circuitry is configured to cause the user equipment to transmit uplink reference signals towards the network node and uplink data and the DMRS on the uplink data channel, in accordance with the configuration, towards the network node, thereby assisting the network node in estimating the radio propagation channel.

According to a seventh aspect there is presented a user equipment for assisting a network node in estimating a radio propagation channel. The user equipment is configured to be served by the network node over the radio propagation channel. The user equipment comprises a receive module configured to receive configuration from the network node for the user equipment to use single port transmission for transmitting on an uplink data channel to the network node. The user equipment comprises a receive module configured to receive downlink control information from the network node. The downlink control information indicates which port the user equipment is to use for transmission of DMRS on the uplink data channel. The user equipment comprises a transmit module configured to transmit uplink reference signals towards the network node and uplink data and the DMRS on the uplink data channel, in accordance with the configuration, towards the network node, thereby assisting the network node in estimating the radio propagation channel.

According to an eighth aspect there is presented a computer program for assisting a network node in estimating a radio propagation channel, the computer program comprising computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide accurate estimations of the radio propagation channel and the null space of the radio propagation channel.

Advantageously, using accurate estimations of the radio propagation channel and the null space of the radio propagation channel aspects enable the PAPR to be reduced whilst still enabling EVM requirements to be fulfilled.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a signalling diagram according to an example;

FIG. 2 is a schematic illustration of one RB of an OFDM symbol according to an example;

FIG. 3 is a schematic illustration of PAPR versus receiver EVM according to an example;

FIG. 4 is a schematic diagram illustrating a wireless communication network according to embodiments;

FIG. 5 is a block diagram of a network node according to embodiments;

FIGS. 6 and 7 are flowcharts of methods according to embodiments;

FIG. 8 shows simulation results in terms of PAPR as a function of number of iterations according to embodiments;

FIG. 9 is a schematic diagram showing functional units of a network node according to an embodiment;

FIG. 10 is a schematic diagram showing functional modules of a network node according to an embodiment;

FIG. 11 is a schematic diagram showing functional units of a user equipment according to an embodiment;

FIG. 12 is a schematic diagram showing functional modules of a user equipment according to an embodiment; and

FIG. 13 shows one example of a computer program product comprising computer readable means according to an embodiment.

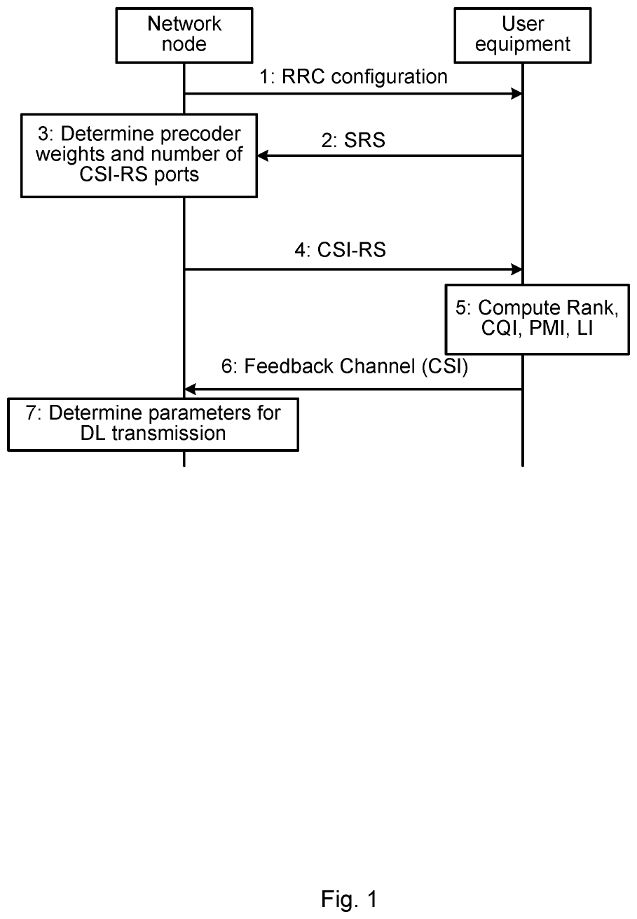

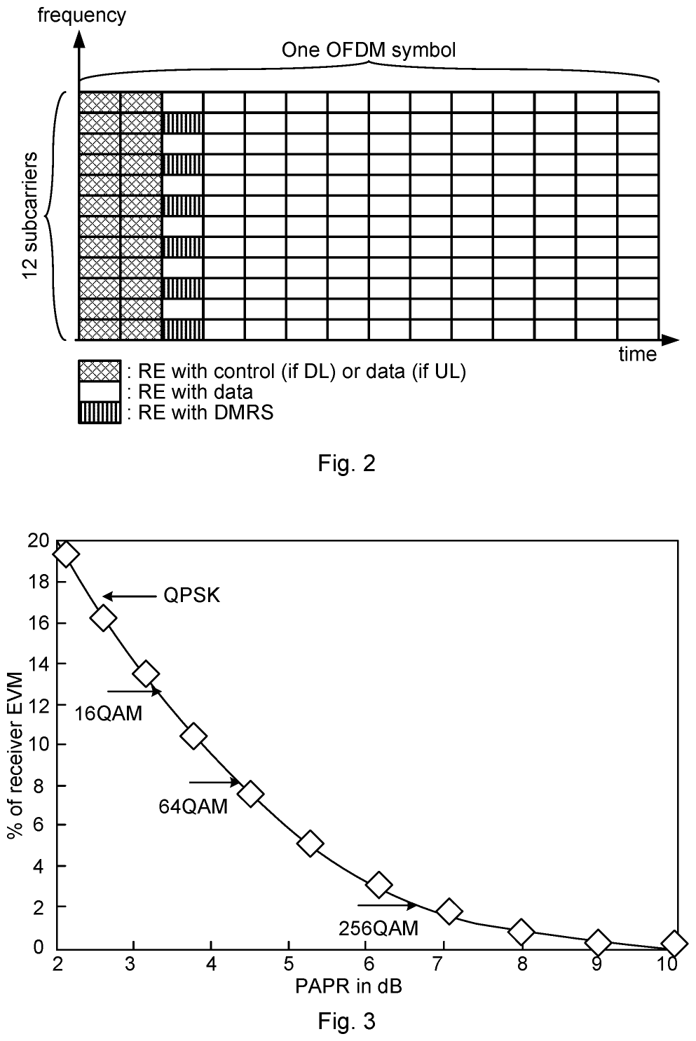

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The embodiments disclosed herein relate to mechanisms for estimating a radio propagation channel and for assisting a network node in estimating a radio propagation channel. In order to obtain such mechanisms there is provided a network node, a method performed by the network node, a computer program product comprising code, for example in the form of a computer program, that when run on processing circuitry of the network node, causes the network node to perform the method. In order to obtain such mechanisms there is further provided a user equipment, a method performed by the user equipment, and a computer program product comprising code, for example in the form of a computer program, that when run on processing circuitry of the user equipment, causes the user equipment to perform the method.

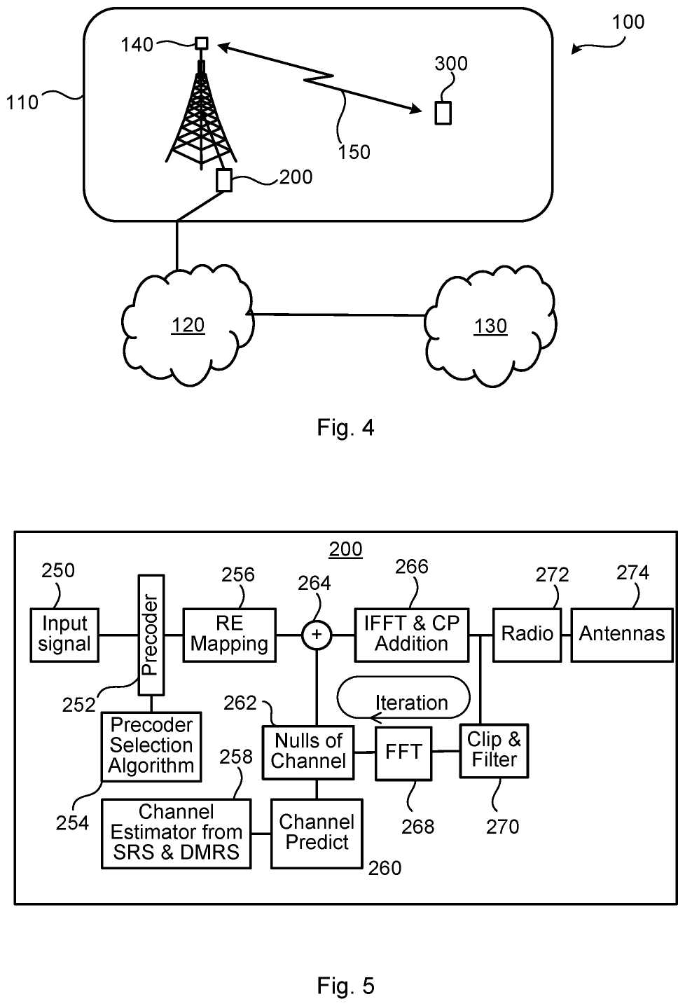

FIG. 4 is a schematic diagram illustrating an example wireless communication network 100 where embodiments presented herein can be applied. The wireless communication network 100 could be a third generation (3G) telecommunications network, a fourth generation (4G) telecommunications network, a fifth generation (5G) telecommunications network, or any evolvement thereof, and support any 3GPP telecommunications standard, where applicable. The wireless communication network 100 could alternatively be a non-cellular and/or a non-3GPP network, such as an IEEE 802.11 communications network, or any other wireless IEEE compliant communications network. The communication wireless network 100 comprises a network node 200 provided in a (radio) access network 110. The network node 200 is configured to, via a transmission and reception point 140, provide network access to user equipment 300 over a radio propagation channel 150. The (radio) access network 110 is operatively connected to a core network 120. The core network 120 is in turn operatively connected to a service network 130, such as the Internet. The user equipment 300 is thereby enabled to, via the network node 200 and its transmission and reception point 140, access services of, and exchange data with, the service network 130. Examples of network nodes 200 are radio access network nodes, radio base stations, base transceiver stations, Node Bs, evolved Node Bs, gNBs, access points, and integrated access and backhaul nodes. Examples of user equipment 300 are wireless devices, mobile stations, mobile phones, handsets, wireless local loop phones, smartphones, laptop computers, tablet computers, network equipped sensors, network equipped vehicles, and so-called Internet of Things devices.

According to herein disclosed embodiments, to obtain accurate estimate of the null space of the radio propagation channel 150, the network node 200 utilizes DMRS received from the user equipment 300 in addition to the uplink reference signals. A block diagram of a network node 200 is shown in FIG. 5. A signal block 250 provides symbols to be transmitted. The symbols are precoded by a precoder block 252 according to a precoder algorithm selected by a precoder selection algorithm block 254. In a RE mapping block, the symbols are mapped to REs. A channel estimator block 258 provides a channel estimate of the radio propagation channel 150 to a channel predictor block 260. The channel estimate might be obtained from a CSI report or utilizing reciprocity-based techniques. A channel null block 262 determines a null space estimate of the radio propagation channel 150 from received uplink reference signals and received DMRS. An IFFT is applied and a circular prefix (CP) is added to the signal by an IFFT and CP addition block 266. After precoding and application of the IFFT and CP addition block 266, the signal goes through a clip and filter block 270 to lower the PAPR and remove out-of-band distortion, and then an FFT is applied at an FFT block 268. However, clipping introduces in-band error distortion. This in-band error distortion defines an error signal and is projected into the null space, as given by the null space estimate, of the radio propagation channel 150, e.g., using beamforming. The thus beamformed error signal is together with the input signal used as input to an adder block 264 and then converted to radio frequency by a radio block 272. Finally, the signal is transmitted from an antenna block 274 comprising one or more antenna arrays.

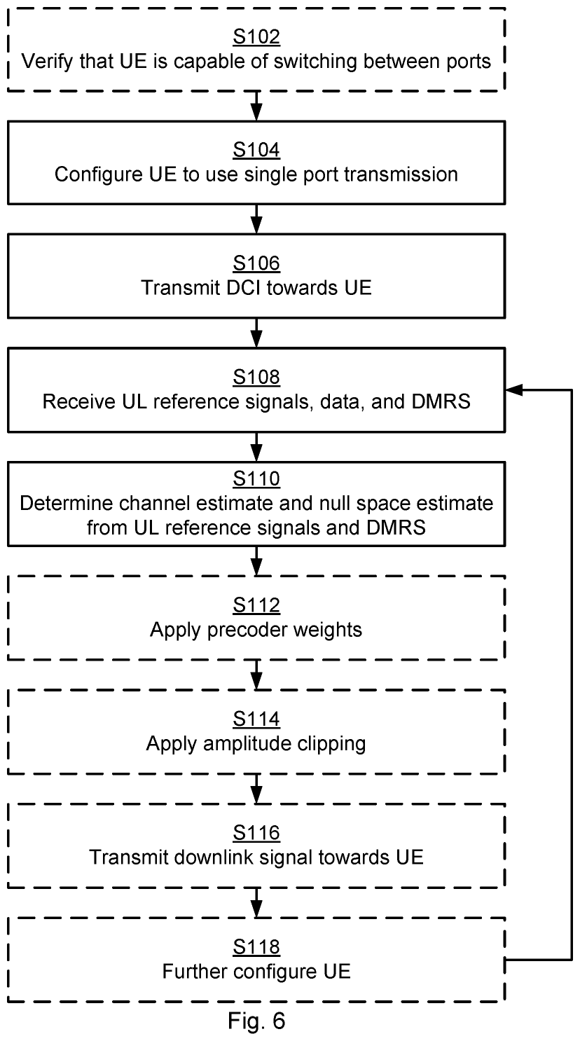

Reference is now made to FIG. 6 illustrating a method for estimating a radio propagation channel 150 as performed by the network node 200 according to an embodiment. The network node 200 is serving a user equipment 300 over the radio propagation channel 150. The network node 200 indicates to the user equipment 300 which port the user equipment 300 is to be used for uplink data transmission, and estimates the radio propagation channel 150 and the null space from received DMRSs in addition to uplink reference signals.

S104: The network node 200 configures the user equipment 300 to use single port transmission for transmitting on an uplink data channel to the network node 200.

S106: The network node 200 transmits downlink control information towards the user equipment 300. The downlink control information indicates which port the user equipment 300 is to use for transmission of DMRS on the uplink data channel.

S108: The network node 200 receives uplink reference signals from the user equipment 300 and uplink data and the DMRS on the uplink data channel from the user equipment 300. In some examples, the uplink reference signals are received on an uplink control channel.

S110: The network node 200 determines a channel estimate of the radio propagation channel 150, and a null space estimate of the radio propagation channel 150, from the received uplink reference signals and the received DMRS.

Since the null space estimate is obtained from both the received uplink reference signals and the received DMRS, this provides an accurate estimation of the null space (as well as of the radio propagation channel 150 itself). In turn, this method can therefore be used to significantly reduce the PAPR and at the same time satisfying EVM requirements. DMRS port switching can be used to accurately exploit the channel nulls for all ports. In this method, the network node 200 indicates to the user equipment 300 on which antenna port the user equipment 300 needs to send the uplink DMRS. This enables the network node 200 to estimate the radio propagation channel 150 and its null space from not only the uplink reference signals but also the uplink DMRS. In turn, this enables the network node 200 to compute the null space of the radio propagation channel 150 with higher accuracy.

Embodiments relating to further details of estimating a radio propagation channel 150 as performed by the network node 200 will now be disclosed.

In some aspects, the network node 200 obtains information whether the user equipment 300 is capable of transmitting on different antenna ports for uplink data transmission. In particular, in some embodiments, the network node 200 is configured to perform (optional) step S102:

S102: The network node 200 verifies that the user equipment 300 is configurable to selectively switch transmission on the uplink data channel between at least two ports.

Aspects of how the network node 200 might determine the null space estimate of the radio propagation channel 150 from the received uplink reference signals and the received DMRS will be disclosed next.

The channel estimate as estimated from the uplink reference signal and the DMRS might be outdated at the time of subsequent data transmission from the network node 200. Therefore, when the error is projected onto the null space, some portion of the residual error remains as the estimated null space is not completely orthogonal to the actual channel. To mitigate this, in some embodiments, the null space estimate is determined as a function of a channel prediction of the radio propagation channel 150, where the channel prediction is a function of the channel estimate. Channel prediction can be used to predict future channel states from current and past channel observations. Once the radio propagation channel is predicted, the null space estimate can be determined as:

$${P}_{N} = I - {H}_{pred}^{+} {H}_{pred} , \qquad ( 4 )$$

where P_{N} is a mapping to the null space, I is an identity matrix, H_{pred} is the channel prediction and H_{pred}⁺ is a pseudoinverse of the channel prediction. P_{N} can thus be regarded as the orthogonal projection matrix onto the null space of the channel prediction H_{pred}. In some examples, the matrix H_{pred}⁺ is the Moore-Penrose inverse of the channel prediction.

The channel prediction can be based on scheduling delay values, speed of travel of the user equipment 150, measurements on uplink reference signals, etc. In some embodiments, the channel prediction further is determined as a function of a weight matrix with weight values. In some embodiments, the channel prediction is determined as:

$${H}_{pred} = {\sum }_{m = 0}^{M - 1} {W}_{m} {H}_{est} , \qquad ( 1 )$$

where H_{pred} is the channel prediction, Wₘ is the weight matrix with weight values, Hₑₛₜ is the channel estimate, and M is number of taps invoked to predict the radio propagation channel 150.

In some examples, the weight values of the weight matrix depend on an estimated speed of travel of the user equipment 300. The weight matrix might be computed based on the minimum mean square error (MMSE) or recursive least squares (RLS) or normalized linear mean square (NLMS) criteria.

In some aspects, the number of taps invoked to predict the channel depends on the user speed. That is, in some embodiments, the number of taps depends on a scheduling delay for the user equipment 300 or an estimated speed of travel of the user equipment 300. In some examples, the value of M depends on the scheduling delay. For example, the value of M might be linearly or non-linearly proportional to the scheduling delay

There could be different uses of the determined null space estimate of the radio propagation channel 150. In some aspects, once the null space has been estimated (by the null space estimate being determined), the network node 200 uses clipping and filtering to clip and filter the baseband time-domain signal to a desired PAPR level and puts the error signal in the null space. This will reduce the EVM. Hence, in some aspects the network node 200 utilizes the determined null space estimate when transmitting downlink signals. Details of an embodiment relating to such transmission of downlink signals will now be disclosed. In general terms, precoding and clipping is applied to a downlink signal to be transmitted. The clipping distortion is then hidden by being transmitted in the null space. Particularly, in some embodiments, the network node 200 is configured to perform (optional) steps S112, S114, and S116:

S112: The network node 200 applies precoder weights to a downlink signal carrying the downlink data transmission towards the user equipment 300.

S114: The network node 200 applies amplitude clipping to the downlink signal. The amplitude clipping yielding an in-band error signal.

S116: The network node 200 transmits the downlink signal. The in-band error signal is projected into a null space given by the null space estimate.

In some embodiments, the precoder weights are determined as a function of channel state information received from the user equipment 300, the uplink reference signals, and/or the DMRS.

As disclosed above, the null space estimate of the radio propagation channel 150 is determined based on the channel estimation from uplink reference signals and the DMRS. Since the DMRS is a single-port signal (i.e., only transmitted on one port, as configured by the network node 200), the network node 200 might not obtain complete channel information from a single transmission instance of the uplink reference signals and the DMRS. DMRS port switching can therefore be applied. Accordingly, the network node 200 might configure, or instruct, the user equipment 300 to sequentially in time transmit the DMRS on different ports. Hence, in some embodiments, according to the configuring, the user equipment 300 is configured to use a first port for transmitting on the uplink data channel to the network node 200, and the network node 200 is configured to perform (optional) step S118:

S118: The network node 200 configures the user equipment 300 to use a second port, different from the first port, for a next-most in time occurring transmission on the uplink data channel to the network node 200.

The configuration in S118 might be provided using downlink control channel signalling.

As an example, assume that the user equipment 300 is configured to transmit on three ports; port 0, port 1, and port 2. The user equipment 300 can then by the network node 200 configured to at time instance n transmit the DMRS from port 0, at time instance n+1 transmit the DMRS from port 1, at time instance n+2 transmit the DMRS from port 2, and at time instance n+3 transmit the DMRS from port 0, and so on.

In some aspects, the network node 200 dynamically configures the user equipment 300 to use DMRS port switching. Hence, in some embodiments, the user equipment 300 is dynamically configured by the network node 200 to, in time and from one transmission on the uplink data channel to the network node 200 to a next transmission on the uplink data channel to the network node 200, switch from using one port to using another port when transmitting on the uplink data channel to the network node 200.

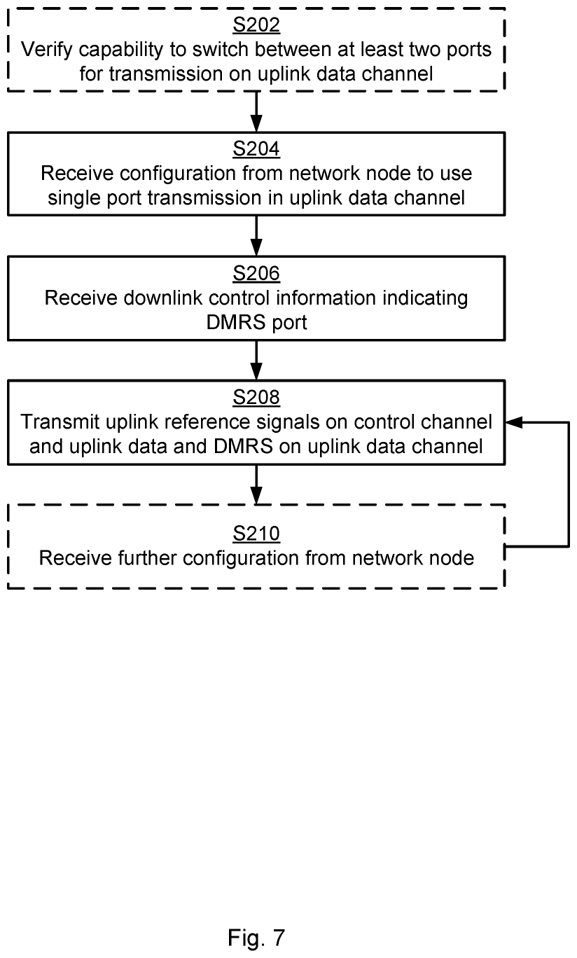

Reference is now made to FIG. 7 illustrating a method for assisting a network node 200 in estimating a radio propagation channel 150 as performed by the user equipment 300 according to an embodiment. The user equipment 300 is served by the network node 200 over the radio propagation channel 150.

S204: The user equipment 300 receives configuration from the network node 200 for the user equipment 300 to use single port transmission for transmitting on an uplink data channel to the network node 200.

S206: The user equipment 300 receives downlink control information from the network node 200. The downlink control information indicates which port the user equipment 300 is to use for transmission of DMRS on the uplink data channel.

S208: The user equipment 300 transmits uplink reference signals towards the network node 200 and uplink data and the DMRS on the uplink data channel, in accordance with the configuration, towards the network node 200. The user equipment 300 thereby assists the network node 200 in estimating the radio propagation channel 150. In some examples, the uplink reference signals are transmitted on an uplink control channel.

Embodiments relating to further details of assisting a network node 200 in estimating a radio propagation channel 150 as performed by the user equipment 300 will now be disclosed.

As disclosed above, the network node 200 might verify that the user equipment 300 is configurable to switch the transmit on the uplink data channel between at least two ports. Hence, in some embodiments, the user equipment 300 is configured to perform (optional) step S202:

S202: The user equipment 300 verifies to the network node 200 that the user equipment 300 is configurable to switch the transmit on the uplink data channel between at least two ports.

As disclosed above, the network node 200 might configure the user equipment 300 to use DMRS port switching as in S118. Hence, in some embodiments, according to the configuration, the user equipment 300 is configured to use a first port for transmitting on the uplink data channel to the network node 200, and the user equipment 300 is configured to perform (optional) step S210:

S210: The user equipment 300 receives further configuration from the network node 200 for the user equipment 300 to use a second port, different from the first port, for a next-most in time occurring transmission on the uplink data channel to the network node 200.

As disclosed above, the network node 200 might dynamically configure the user equipment 300 to use DMRS port switching. Particularly, in some embodiments, according to the configuration, the user equipment 300 is dynamically configured to, from one transmission on the uplink data channel to the network node 200 to a next transmission on the uplink data channel to the network node 200, switch from using one port to using another port when transmitting on the uplink data channel to the network node 200.

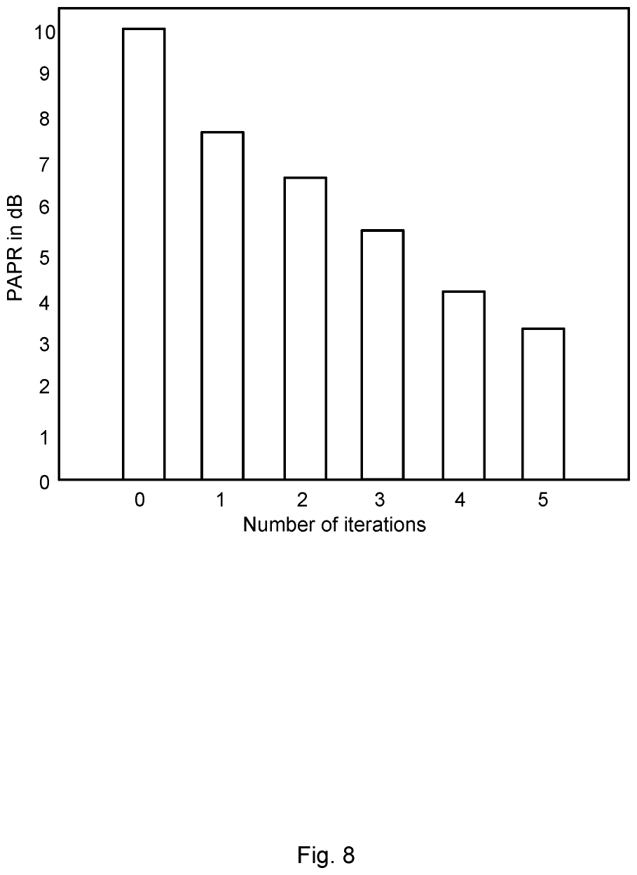

Simulation results will be disclosed next. FIG. 8 shows simulation results in terms of PAPR as a function of number of iterations according to embodiments where both uplink reference signals and DMRS are used when determining the null space estimates. Table 2 lists simulation parameters. Table 3 shows the EVM at each of the iterations in FIG. 8 and Table 4 shows the PAPR versus EVM for each listed modulation. The EVM satisfies the EVM requirements in Table 1 whilst the PAPR at the same time being significantly reduced.

TABLE 2
List of simulation parameters

| Assumptions | Value |
|---|---|
| Carrier frequency | 3.5 GHz |
| Duplex mode | Time-division duplex (TDD) |
| System Bandwidth | 10 MHz |
| Slot length | 1 ms (14 OFDM symbols) |
| Subcarrier spacing | 15 KHz |
| Guard time interval | 4.7 μs |
| FFT size | 2048 |
| Data transmission | 52 physical resource blocks (PRBs) |
| bandwidth | |
| Antenna configuration | TRP with 32 antenna elements, user |
| | equipment with 4 receiving antennas |
| Number of CSI-RS ports | 32 |
| Channel encoder | New radio low-density parity.-check |
| | (NR-LDPC) code |
| Modulation and coding | For link adaptation: QPSK, 16-QAM, |
| scheme (MCS) | 64-QAM 256 QAM are considered |
| | with variable code rate |
| Control Overhead | 2 OFDM symbols |
| Channel estimation | Practical channel estimation |
| Channel model | CDL-A cross pole |
| UE speed | 3 km/h |
| DMRS configuration | Type 1 configuration with frontloaded on |
| | third OFDM symbol with one additional |
| | DMRS |
| Feedback delay | 4 slots |

TABLE 3
EVM for each iteration

| Number of Iterations | EVM (%) |
|---|---|
| 1 | 0.0055 |
| 2 | 0.0094 |
| 3 | 0.0139 |
| 4 | 0.0184 |
| 5 | 0.023 |

TABLE 4
PAPR and EVM for each modulation after 5 iterations

| Modulation | PAPR (dB) | EVM (%) |
|---|---|---|
| QPSK | 3.45 | 0.02 |
| 16 QAM | 3.43 | 0.02 |
| 64 QAM | 3.46 | 0.02 |
| 256 QAM | 3.37 | 0.02 |

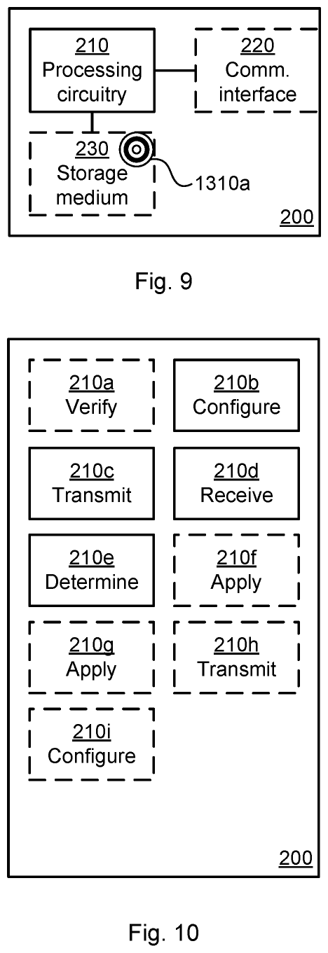

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; a configure module 210b configured to perform step S104, a transmit module 210c configured to perform step S106, a receive module 210d configured to perform step S108, and a determine module 210e configured to perform step S110. The network node 200 of FIG. 10 may further comprise a number of optional functional modules, such as any of a verify module 210a configured to perform step S102, an apply module 210f configured to perform step S112, an apply module 210g configured to perform step S114, a transmit module 210h configured to perform step S116, a configure module 210i configured to perform step S118. In general terms, each functional module 210a:210i may be implemented in hardware or in software. Preferably, one or more or all functional modules 210a:210i may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210i and to execute these instructions, thereby performing any steps of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a:210i of FIG. 10 and the computer program 1320a of FIG. 13.

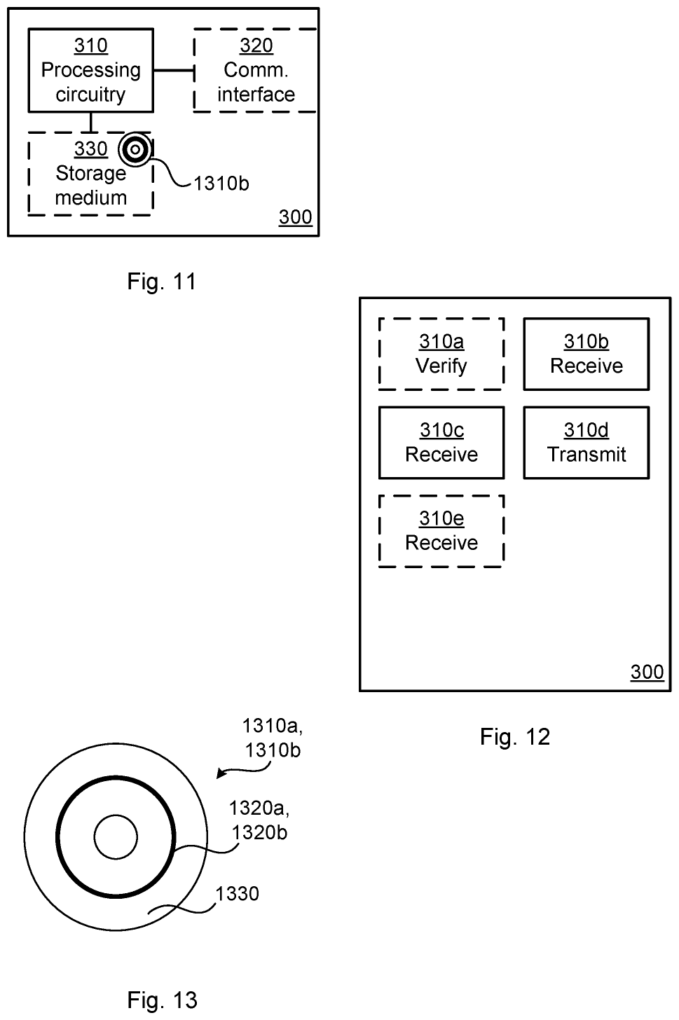

FIG. 11 schematically illustrates, in terms of a number of functional units, the components of a user equipment 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300 to perform a set of operations, or steps, as disclosed above. For example, the storage medium 330 may store the set of operations, and the processing circuitry 310 may be configured to retrieve the set of operations from the storage medium 330 to cause the user equipment 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300 may further comprise a communications interface 320 for communications with other entities, functions, nodes. As such the communications interface 320 may comprise one or more transmitters and receivers, comprising analogue and digital components.

The processing circuitry 310 controls the general operation of the user equipment 300 e.g. by sending data and control signals to the communications interface 320 and the storage medium 330, by receiving data and reports from the communications interface 320, and by retrieving data and instructions from the storage medium 330. Other components, as well as the related functionality, of the user equipment 300 are omitted in order not to obscure the concepts presented herein.

FIG. 12 schematically illustrates, in terms of a number of functional modules, the components of a user equipment 300 according to an embodiment. The user equipment 300 of FIG. 12 comprises a number of functional modules; a receive module 310b configured to perform step S204, a receive module 310c configured to perform step S206, and a transmit module 310d configured to perform step S208. The user equipment 300 of FIG. 12 may further comprise a number of optional functional modules, such as any of a verify module 310a configured to perform step S302 and a receive module 310e configured to perform step S310. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the user equipment 300 as disclosed herein.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the network node 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the user equipment 300 as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for estimating a radio propagation channel, the method being performed by a network node, the network node serving a user equipment over the radio propagation channel, the method comprising:
configuring the user equipment to use single port transmission for transmitting on an uplink data channel to the network node;
transmitting downlink control information towards the user equipment, wherein the downlink control information indicates which port the user equipment is to use for transmission of demodulation reference signals (DMRS) on the uplink data channel;
receiving uplink reference signals from the user equipment and uplink data and the DMRS on the uplink data channel from the user equipment; and
determining a channel estimate of the radio propagation channel, and a null space estimate of the radio propagation channel, from the received uplink reference signals and the received DMRS.

2. The method according to claim 1, wherein the method further comprises:
verifying that the user equipment is configurable to selectively switch transmission on the uplink data channel between at least two ports.

3. The method according to claim 1, wherein the null space estimate is determined as a function of a channel prediction of the radio propagation channel, where the channel prediction is a function of the channel estimate.

4. The method according to claim 3, wherein the null space estimate is determined as:
$${P}_{N} = I - {H}_{pred}^{+} {H}_{pred}$$
where P_{N} is a mapping to the null space, I is an identity matrix, H_{pred} is the channel prediction and H_{pred}⁺ is a pseudoinverse of the channel prediction.

5. The method according to claim 3, wherein the channel prediction further is determined as a function of a weight matrix with weight values.

6-8. (canceled)

9. The method according to claim 1, wherein the method further comprises:
applying precoder weights to a downlink signal carrying the downlink data transmission towards the user equipment;
applying amplitude clipping to the downlink signal, the amplitude clipping yielding an in-band error signal; and
transmitting the downlink signal, wherein the in-band error signal is projected into a null space given by the null space estimate.

10. The method according to claim 9, wherein the precoder weights are determined as a function of channel state information received from the user equipment, the uplink reference signals, and/or the DMRS.

11. The method according to claim 1, wherein according to the configuring, the user equipment is configured to use a first port for transmitting on the uplink data channel to the network node, the method further comprises:
configuring the user equipment to use a second port, different from the first port, for a next-most in time occurring transmission on the uplink data channel to the network node.

12. The method according to claim 1, wherein the network node dynamically configures the user equipment to, from one transmission on the uplink data channel to the network node to a next transmission on the uplink data channel to the network node, switch from using one port to using another port when transmitting on the uplink data channel to the network node.

13. A method for assisting a network node in estimating a radio propagation channel, the method being performed by a user equipment being served by the network node over the radio propagation channel, the method comprising:
receiving configuration from the network node for the user equipment to use single port transmission for transmitting on an uplink data channel to the network node;
receiving downlink control information from the network node, wherein the downlink control information indicates which port the user equipment is to use for transmission of demodulation reference signals (DMRS) on the uplink data channel; and
transmitting uplink reference signals towards the network node and uplink data and the DMRS on the uplink data channel, in accordance with the configuration, towards the network node, thereby assisting the network node in estimating the radio propagation channel.

14. The method according to claim 13, wherein the method further comprises:
verifying to the network node that the user equipment is configurable to switch the transmit on the uplink data channel between at least two ports.

15. The method according to claim 13, wherein, according to the configuration, the user equipment is configured to use a first port for transmitting on the uplink data channel to the network node, the method further comprises:
receiving further configuration from the network node for the user equipment to use a second port, different from the first port, for a next-most in time occurring transmission on the uplink data channel to the network node.

16. The method according to claim 13, wherein, according to the configuration, the user equipment is dynamically configured to, from one transmission on the uplink data channel to the network node to a next transmission on the uplink data channel to the network node, switch from using one port to using another port when transmitting on the uplink data channel to the network node.

17. A network node for estimating a radio propagation channel, the network node being configured to serve a user equipment over the radio propagation channel, the network node comprising processing circuitry, the processing circuitry being configured to cause the network node to:
configure the user equipment to use single port transmission for transmitting on an uplink data channel to the network node;
transmit downlink control information towards the user equipment, wherein the downlink control information indicates which port the user equipment is to use for transmission of demodulation reference signals (DMRS) on the uplink data channel;
receive uplink reference signals from the user equipment and uplink data and the DMRS on the uplink data channel from the user equipment; and
determine a channel estimate of the radio propagation channel, and a null space estimate of the radio propagation channel, from the received uplink reference signals and the received DMRS.

18-19. (canceled)

20. A user equipment for assisting a network node in estimating a radio propagation channel, the user equipment being configured to be served by the network node over the radio propagation channel, the user equipment comprising processing circuitry, the processing circuitry being configured to cause the user equipment to:
receive configuration from the network node for the user equipment to use single port transmission for transmitting on an uplink data channel to the network node;
receive downlink control information from the network node, wherein the downlink control information indicates which port the user equipment is to use for transmission of demodulation reference signals (DMRS) on the uplink data channel; and
transmit uplink reference signals towards the network node and uplink data and the DMRS on the uplink data channel, in accordance with the configuration, towards the network node, thereby assisting the network node in estimating the radio propagation channel.

21-22. (canceled)

23. A computer program product for estimating a radio propagation channel, the computer program product comprising a non-transitory computer readable medium storing a computer program comprising instructions which, when run on processing circuitry of a network node configured to serve a user equipment over the radio propagation channel, causes the network node to carry out the method according to claim 1.

24. A computer program product for assisting a network node in estimating a radio propagation channel, the computer program product comprising a non-transitory computer readable medium storing a computer program comprising instructions which, when run on processing circuitry of a user equipment configured to be served by the network node over the radio propagation channel, causes the user equipment to carry out the method according to claim 13.

25. (canceled)
